(19) United States
(12) Patent Application Publication
(10) Pub. No.: US 2015/0153878 A1
(43) Pub. Date: Jun. 4, 2015

(54) METHOD OF PROCESSING DATA BY TOUCH SCREEN, STORAGE MEDIUM, AND ELECTRONIC DEVICE

(71) Applicant: Samsung Electronics Co., Ltd., Suwon-si (KR)

(72) Inventor: Byeong Jae KIM, Dongducheon-si (KR)

(21) Appl. No.: 14/557,963

(22) Filed: Dec. 2, 2014

(30) Foreign Application Priority Data
Dec. 2, 2013 (KR) 10-2013-0148675

(51) Int. Cl. G06F 3/044

(52) U.S. Cl. CPC G06F 3/044

(57) ABSTRACT

A method of processing data by a touch screen is provided. The method includes receiving signals having signal values from a touch panel, identifying parameters for compressing the signal values of the received signals, compressing the signal values based on the parameters, and transmitting the compressed signal values to a controller through an interface of the touch screen.

### CROSS-REFERENCE TO RELATED APPLICATION(S)

This application claims the benefit under 35 U.S.C. §119(a) of a Korean patent application filed on Dec. 2, 2013 in the Korean Intellectual Property Office and assigned Serial number 10-2013-0148675, the entire disclosure of which is hereby incorporated by reference.

### TECHNICAL FIELD

The present disclosure relates to a touch screen.

### BACKGROUND

A touch screen refers to an input device that detects a position of a person's finger or a tool that approaches the touch screen.

A general touch screen includes a touch panel that generates signals according to a contact or proximity of an input device (for example, a finger, a stylus pen or the like) and is electrically connected to a touch screen controller. The touch screen controller detects a change in signals of the touch panel according to the contact or proximity of the input device and determines a position of a contact or proximity on the touch panel.

An Inter-Integrated Circuit (I2C), a Serial Peripheral Interface (SPI), a Universal Serial Bus (USB) and the like are used as a communication means between the touch screen controller and a controller of an electronic device. Among them, the I2C is common due to low cost and a simple hardware configuration.

The above information is presented as background information only to assist with an understanding of the present disclosure. No determination has been made, and no assertion is made, as to whether any of the above might be applicable as prior art with regard to the present disclosure.

### SUMMARY

In the related art, a controller uses only user input information of a touch screen. Further, since an interface such as an Inter-Integrated Circuit (I2C), which is simple, low cost, and includes a slow transmission rate, a touch screen controller has a difficulty in transmitting raw data from a touch panel to the controller.

Aspects of the present disclosure are to address at least the above-mentioned problems and/or disadvantages and to provide at least the advantages described below. Accordingly, an aspect of the present disclosure is to provide a method of processing data by a touch screen.

In accordance with an aspect of the present disclosure, a method of processing data by a touch screen is provided. The method includes receiving signals having signal vales from a touch panel, identifying parameters for compressing the signal values of the received signals, compressing the signal values based on the one or more parameters, and transmitting the compressed signal values to a controller through an interface of the touch screen.

In accordance with another aspect of the present disclosure, a touch screen is provided. The touch screen includes a touch panel for outputting signals having signal values in response to a touch, a memory for storing parameters for compressing the signal values of the signals, an interface for communication with a controller, and a touch screen controller configured to compress the signal values based on the parameters and to transmit the compressed signal values to the controller through the interface.

According to various embodiment of the present disclosure, a controller can identify raw data of a touch screen based on a short period.

According to various embodiments of the present disclosure, a controller can perform a high level algorithm using raw data, which cannot be performed by a touch screen.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an electronic device according to an embodiment of the present disclosure;

FIG. 2 illustrates a configuration of a touch screen according to an embodiment of the present disclosure;

FIG. 3 is a flowchart illustrating a method of processing data by a touch screen according to an embodiment of the present disclosure;

FIG. 4 is a flowchart illustrating a method of compressing signal values according to an embodiment of the present disclosure;

FIGS. 5A, 5B, 5C, and 5D are views describing self-capacitance values and mutual-capacitance values according to an embodiment of the present disclosure;

FIGS. 6A, 6B, and 6C are views describing Discrete Cosine Transform (DCT) and quantization according to an embodiment of the present disclosure;

FIGS. 7A, 7B, 7C, and 7D are views describing an extension of self-capacitance values in a column direction and calculation and quantization of DCT coefficients according to an embodiment of the present disclosure; and

FIGS. 8A, 8B, and 8C are views describing DCT and quantization for mutual-capacitance values according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Although the terms including an ordinal number such as first, second, etc. can be used for describing various elements, the structural elements are not restricted by the terms. The terms are only used to distinguish one element from another element. For example, without departing from the scope of the present disclosure, a first structural element may be named a second structural element. Similarly, the second structural element also may be named the first structural element. As used herein, the term “and/or” includes any and all combinations of one or more associated items.

The terms used in this application is for the purpose of describing particular embodiments only and is not intended to limit the disclosure. As used herein, the singular forms are intended to include the plural forms as well, unless the context clearly indicates otherwise. In the description, it should be understood that the terms “include” or “have” indicate existence of a feature, a number, a step, an operation, a structural element, parts, or a combination thereof, and do not previously exclude the existences or probability of addition of one or more another features, numeral, steps, operations, structural elements, parts, or combinations thereof.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present specification.

In the present disclosure, an electronic device may be any device including a touchscreen, and may also be called a terminal, a portable terminal, a mobile terminal, a communication terminal, a portable communication terminal, a portable mobile terminal, a display device, or the like.

For example, the electronic device may be a smartphone, a portable phone, a game player, a TeleVision (TV), a display unit, a heads-up display unit for a vehicle, a notebook computer, a laptop computer, a tablet Personal Computer (PC), a Personal Media Player (PMP), a Personal Digital Assistants (PDA), and the like. The electronic device may be implemented as a portable communication terminal which has a wireless communication function and fits within a pocket. Further, the electronic device may be a flexible device or a flexible display unit.

The electronic device may communicate with an external electronic device, such as a server or the like, or perform an operation through an interworking with the external electronic device. For example, the electronic device may transmit an image photographed by a camera and/or position information detected by a sensor unit to the server through a network. The network may be a mobile or cellular communication network, a Local Area Network (LAN), a Wireless Local Area Network (WLAN), a Wide Area Network (WAN), an Internet, a Small Area Network (SAN) or the like, but is not limited thereto.

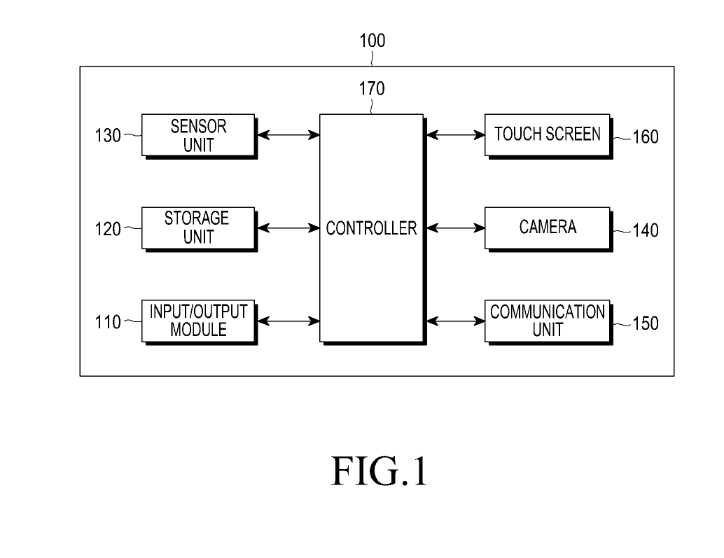

FIG. 1 illustrates an electronic device according to an embodiment of the present disclosure.

Referring to FIG. 1, an electronic device 100 may include an input/output module 110, a storage unit 120, a sensor unit 130, a camera 140, a communication unit 150, a touch screen 160, and a controller 170. For purposes of succinctness, the electronic device 100 is an example configuration and components of the electronic device 100 may be omitted and modified as necessary.

The first input/output module 110 receives a user input or informs a user of information and may include a plurality of buttons, a microphone, a speaker, a vibration motor, a connector, a keypad, a mouse, a trackball, a joystick, cursor direction keys, a cursor control, or a partial or whole combination thereof.

The button may be formed on a front side, a lateral side, and/or a back side, and may include a power/lock button, a volume button, a menu button, a home button, a back button, or a search button.

The microphone (not shown) receives aural input (e.g., voice or sound) and generates an electrical signal according to a control of the controller 170.

The speaker (not shown) may provide aural output corresponding to various signals (for example, a wireless signal, a broadcasting signal, a digital audio file, a digital video file, capturing a picture, or the like) to the outside of the electronic device 100 according to a control of the controller 170. The speaker may output a sound corresponding to a function performed by the electronic device 100. One or more speakers may be formed at a proper position or proper positions of the electronic device 100.

The vibration motor (not shown) may convert an electrical signal into a mechanical vibration according to a control of the controller 170. For example, when the electronic device 100 in a vibration mode receives a voice call from another electronic device (not shown), the vibration motor operates. One or more vibration motors may be formed within the electronic device 100. The vibration motor may operate in response to a touch action of the user made on the touch screen 160 or successive motions of the touch on the touch screen 160.

The connector (not shown) may be used as an interface for connecting the electronic device 100 with a server, an external electronic device, or a power source. Based on a control of the controller 170, the connector may transmit data stored in the storage unit 120 of the electronic device 100 to an external device or may receive data from an external device when a cable is connected to the connector. Through the cable, electric power can be fed from the power source or a battery can be charged.

The keypad (not shown) may receive a key input from a user for a control of the electronic device 100. The keypad may include a physical keypad formed in the electronic device 100, a virtual keypad display on the display unit 160, or the like.

The storage unit 120 may store data for executing a voice recognition application, a schedule management application, a document generation application, a music application, an Internet application, a map application, a camera application, an e-mail application, an image editing application, a search application, a file search application, a video application, a game application, a Social Network Service (SNS) application, a phone application, or a message application. The storage unit 120 may store images to provide a Graphical User Interface (GUI) related to one or a plurality of applications, databases or data such as user information, documents and the like, background images (a menu screen, an idle screen, and the like) or operating programs for operating the electronic device 100, images captured by a camera, or the like. The storage unit 120 is a medium which is readable using a machine (for example, a computer) and the term, “machine-readable medium,” may be defined as a medium that provides data for the machine to cause the machine to perform a specific function. The machine-readable medium may be a storage medium such as a non-volatile medium, a volatile medium or the like. All of these media should be of a type that allows commands transferred by the media to be detected by a physical mechanism through which the machine reads the commands.

The machine-readable medium includes, but is not limited to, a floppy disk, a flexible disk, a hard disk, a magnetic tape, a Compact Disc Read-Only Memory (CD-ROM), an optical disk, a punch card, a paper tape, a Random Access Memory (RAM), a Programmable Read-Only Memory (PROM), an Erasable PROM (EPROM), a Flash-EPROM, or the like.

The sensor unit 130 may include one or more sensors that detect a state (e.g., position, direction, motion or the like) of the electronic device 100. For example, the sensor unit 130 may include a proximity sensor which detects whether the user approaches the electronic device 100, a motion/orientation sensor which detects the operation of the electronic device 100 (for example, rotation, acceleration, deceleration, vibration, etc. of the electronic device 100), etc. Further, the motion/direction sensor may include an acceleration sensor (or gravity sensor) that measures a slope and detects a change in linear speed, a gyro sensor that detects an angular speed, an impact sensor, a Global Positioning System (GPS) sensor, a compass sensor (or a geomagnetic sensor) that detects a direction, or an inertia sensor that detects inertial force of motion and provides various pieces of information, such as acceleration, speed, direction, and distance of a moving object to be measured. The sensor unit 130 may detect a state of the electronic device 100, may generate a signal corresponding to the detection and transmit the generated signal to the controller 170. For example, the GPS sensor may receive radio waves from a plurality of GPS satellites (not illustrated) that are located in Earth's orbit, and may calculate a GPS location of the electronic device 100 by using a time of arrival of the radio waves from the GPS satellites to the electronic device 100. The compass sensor may calculate an orientation or a point of compass of the electronic device 100.

The camera 140 may include a lens system that enables convergence of light incident from the environment to form an optical image of a subject, an image sensor that converts the optical image into an electrical image signal or data for outputting, and a driving unit that drives an image sensor based on a control of the controller 170, and may further include a flash or the like.

The communication unit 150 is provided for a connection with a server through a network or a direct connection with an external electronic device, and may be a wired or wireless communication unit. Also, the communication unit 150 may transmit data obtained from the controller 170, the storage unit 120, the camera 140, or the like via a wired or a wireless channel. The communication unit 150 may receive data via a wired or wireless channel and transfer the data to the controller 170 or to store the data in the storage unit 120.

The communication unit 150 may include a communication module, a WLAN module, or a LAN module. The communication unit 150, although not limited thereto, may include an Integrated Services Digital Network (ISDN) card, a modem, a LAN card, an infrared ray port, a Bluetooth port, a Zigbee port, a wireless port, or the like.

The communication module (not shown) may connect the electronic device 100 with an external device through mobile communication using one or a plurality of antennas. The mobile communication module transmits/receives a Radio Frequency (RF) signal for exchanging, uni-directionally transmitting, or receiving data of a voice call, a video call, a Short Message Service (SMS), or a Multimedia Message Service (MMS) to/from a portable phone, a smart phone, a tablet PC, another device having a phone number, or a network address input into the electronic device 100.

The WLAN module (not shown) may be connected to the Internet in a place where a wireless Access Point (AP) (not illustrated) is installed. The WLAN module supports a wireless LAN provision of the Institute of American Electrical and Electronics Engineers (IEEE) such as IEEE 802.11ac, for example. The short distance communication module (not shown) may wirelessly perform short distance communication between the electronic device 100 and an image forming apparatus (not illustrated). Short-range communication techniques may include Bluetooth, Infrared Data Association (IrDA), or the like.

The touch screen 160 displays an image or data input from the controller 170. The touch screen 160 displays an image according to a control of the controller 170, may receive user input information including at least an input coordinate or at least an input state, and transmit the received user input information to the controller 170. For example, when a user input means such as a finger, a stylus pen or the like is in contact with or in proximity to a surface of the touch screen 160 (for example, when an interval between the touch screen 160 and a user's body or an input means is larger than 0 and smaller than or equal to 5 cm), the touch screen 160 transmits the received user input information to the controller 170. That is, the touch screen 160 detects a user input and outputs information of the detected user input for the controller 170.

The controller 170 executes an application operation according to the user input information. At this time, the user input includes an input through the input/output module 110, the touch screen 160, the sensor unit 130, an input based on the camera unit 140, or the like. The controller 170 may include a bus for information communication, and a processor connected with the bus for information processing. The controller 170 may include a Central Processing Unit (CPU), an Application Processor (AP), or the like. The controller 170 may be referred to as an application processor or a host controller which has the higher computing capability than that of a touch screen controller and controls (and/or executes) operations of applications within the electronic device 100.

The controller 170 may further include a RAM connected to the bus to temporarily store information required by the processor, a ROM connected to the bus to store static information required by the processor, and the like.

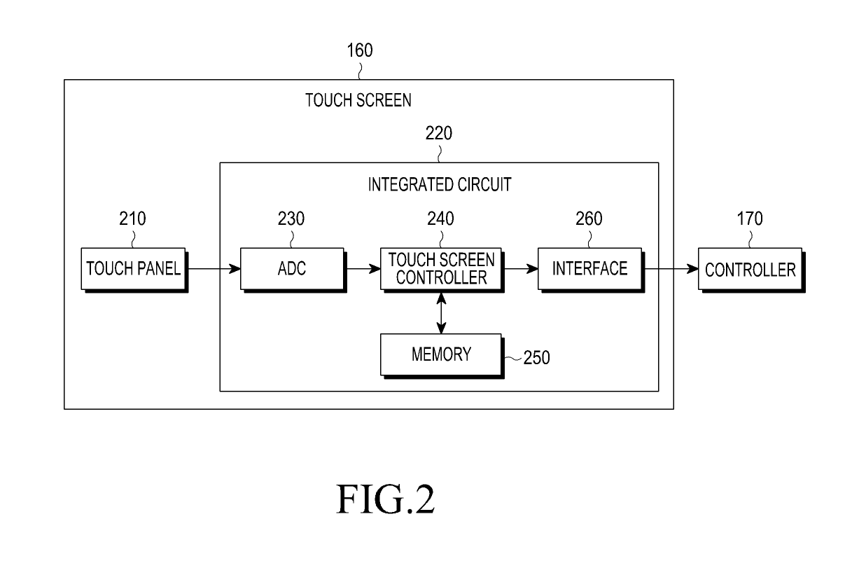

FIG. 2 illustrates a configuration of the touch screen according to an embodiment of the present disclosure.

Referring to FIG. 2, the touch screen 160 includes a touch panel 210 and an integrated circuit 220.

The touch panel 210 includes cells having a matrix structure that output signals to the integrated circuit 220. The cells output distinguishable signals, and may be, for example, electrodes arranged in a matrix structure or intersections of electrodes arranged in a grid form. The signals of the cells may indicate a capacitance value, a voltage value, a current value or the like.

When the touch panel 210 is a touch panel in a capacitive type, signal values of the touch panel 210 may be classified into self-capacitance values and mutual-capacitance values, and the touch panel 210 may output the self-capacitance values and/or the mutual-capacitance values to the integrated circuit 220. The self-capacitance values and mutual-capacitance values may be capacitance values, or voltage values, current values or the like corresponding to the capacitance values.

Hereinafter, although a case where the touch panel 210 is a touch panel in a capacitive type is described, a method of processing data by the touch screen according to various embodiments of the present disclosure may be applied to touch panels in various operation schemes. For example, in addition to the capacitive type, operation types of the touch panel 210 may include a resistive type, an InfraRed (IR) type, a Surface Acoustic Wave (SAW) type, an ElectroMagnetic (EM) type, an ElectroMagnetic Resonance (EMR) type or the like.

The integrated circuit 220 receives signals of cells from the touch panel 210, calculates user input information such as a touch position or coordinate, an intensity, a cell IDentification (ID), a touch angle or a partial or whole combination thereof from signal values of the received signals, and outputs the calculated user input information to the controller 170. In addition to the user input information, the integrated circuit 220 may output device information which may include information such as an ID of the touch panel 210 or the touch screen 160, a row length of the touch panel 210 (or a horizontal direction length or the number of columns), a column length (or a vertical direction length or the number of rows) or a partial or whole combination thereof to the controller 170. Further, the integrated circuit 220 may receive device information from the touch panel 210.

The integrated circuit 220 includes an Analog-to-Digital Converter (ADC) 230, a touch screen controller 240, a memory 250, and an interface 260.

The ADC 230 converts analog signal values input from the touch panel 210 to digital signal values. The digital signal values may be referred to as raw data.

The touch screen controller 240 calculates user input information from digital signal values input from the ADC 230. The touch screen controller 240 outputs the user input information, device information of the touch panel 210, and/or device information of the touch screen 160 to the interface 260. The touch screen controller 240 compresses digital signal values according to a preset compression scheme and outputs the compressed signal values to the interface 260. In an embodiment of the present disclosure, the touch screen controller 240 compresses signal values according to a Discrete Cosine Transform (DCT)-based compression scheme.

The memory 250 may include a Look-Up Table (LUT) that stores cosine values used for the DCT and the LUT may store values of x and y (=cos(x)).

The interface 260 outputs at least one of the compressed signal values, the user input information and the device information (i.e., a partial or whole combination thereof) to the controller 170 according to a preset interface scheme. The preset interface scheme may be I2C, SPI, USB and the like. In an embodiment of the present disclosure, the I2C may be implemented by a simple hardware configuration that is cost effective. The interface 260 is used to provide communication between the touch screen controller 240 and the controller 170. Although not illustrated, the controller 170 may include a second interface operating in the same interface scheme as that of the interface 260. The interface 260 may be located inside the controller 170, not inside the integrated circuit 220, or located between the integrated circuit 220 and the controller 170.

The controller 170 performs an application operation according to the user input information (and the device information) received from the interface 260. For example, when a phone application is being executed, the controller 170 may detect the selection of a call button on the phone application from the user input information and transmit information to a receiving counterpart device. The user input information may contain compressed information. Accordingly, the controller 170 may decompress the compressed signal values and perform a preset operation based on the decompressed signal values (and device information). For example, when a user input means is not in contact with or in proximity to the surface of the touch screen 160 and an error of the signal value is corrected using an offset (i.e., the corrected signal value has a value of 0), the controller 170 may detect signal values having values different from 0 among the decompressed signal values, calculate offset values to be applied to the detected signal values, and transmit the calculated offset values to the touch screen controller 240 through the interface 260. After receiving the offset values, the touch screen controller 240 may output user input information to which the offset is applied.

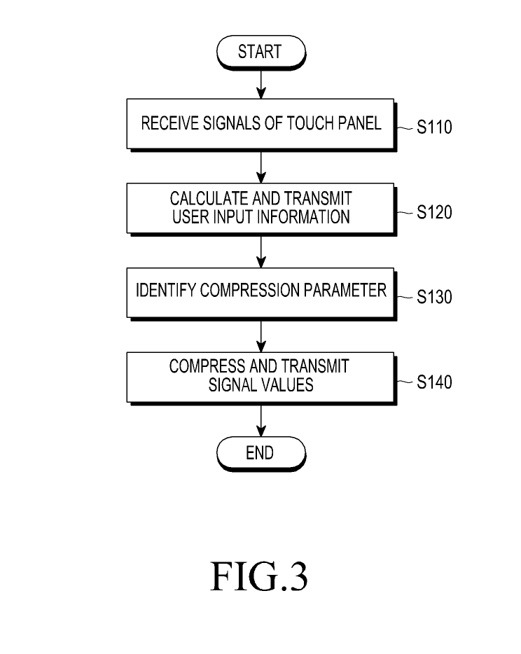

FIG. 3 is a flowchart illustrating a method of processing data by the touch screen according to an embodiment of the present disclosure.

Referring to FIG. 3, the method of processing data by the touch screen includes operations S110 to S140.

In operation S110, the screen controller 240 receives a signal of each cell included in the touch panel 210 from the touch panel 210.

In operation S120, the touch screen controller 240 calculates user input information such as a position or a coordinate of a user input (that is, touch or hovering), an intensity of the user input, a cell ID, a touch angle or a partial or whole combination thereof from the signal values of the signals received from the touch panel 210 and transmits the calculated user input information to the controller 170 through the interface 260.

In operation S130, the touch screen controller 240 identifies or sets a parameter required for compressing the signal values. The parameter may include at least one of selection information of self-capacitance values of a short length, the number of bits of a DCT coefficient, a quantization coefficient, and a LUT storing cosine values used for the DCT. The parameter may be set by the touch screen controller 240 or may be preset, and the touch screen controller 240 may identify a preset parameter stored in the memory 250.

In operation S140, the touch screen controller 240 compresses the signal values according to a DCT-based compression scheme and transmits the compressed signal values to the controller 170 through the interface 260. The DCT-based compression scheme includes DCT and quantization of the signal values.

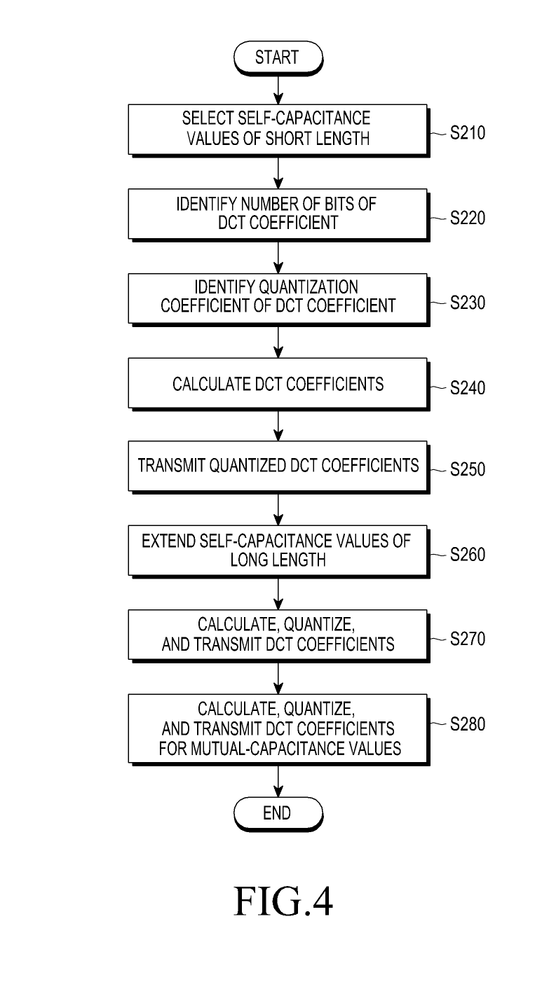

FIG. 4 is a flowchart illustrating a method of compressing signal values according to an embodiment of the present disclosure.

Referring to FIG. 4, the compression method includes operations S210 to S280.

In operation S210, the touch screen controller 240 selects self-capacitance values of a short length from self-capacitance values in row and column directions. In another embodiment of the present disclosure, the touch screen controller 240 selects self-capacitance values in the row direction. Unlike the embodiment of the present disclosure, when the type of signal values is one, operation S210 may be omitted. Further, the touch screen controller 240 may select self-capacitance values in a preset direction from the self-capacitance values in the row and column directions. That is, orders of operations S210 to S250 and operations S260 to S270 may be exchanged with each other. Further, an order of operation S280 may be performed before or between operations S210 to S250 and operations S260 to S270. In addition, transmission of self-capacitance values and mutual-capacitance values may be sequentially performed after the self-capacitance values and the mutual-capacitance values are all completely cosine-transformed and quantized. Furthermore, in the present specification, the row direction and the column direction may be referred to as a first direction and a second direction or a horizontal direction and a vertical direction.

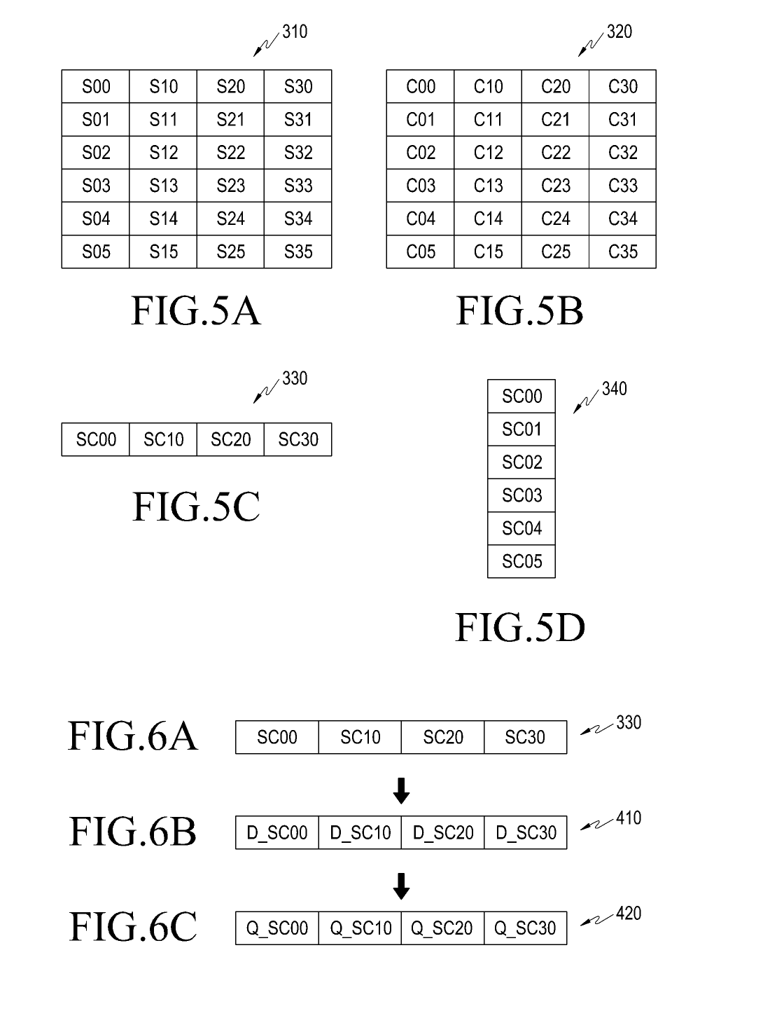

FIGS. 5A to 5D are views describing self-capacitance values and mutual-capacitance values according to an embodiment of the present disclosure.

Referring to FIG. 5A, 4 (row length)*6 (column length) cells 310 (that is, 6 rows and 4 columns) are shown, and a cell of x (=0 to 4) and y (=0 to 6) coordinates is expressed as Sxy.

Referring to FIG. 5B, mutual-capacitance values 320 indicate the signal values output by the cells of the touch panel 210 without any change, and a mutual-capacitance value output by the Sxy cell is expressed as Cxy.

Self-capacitance values express signal values of cells compressed in each of the row and column directions.

Referring to FIG. 5C, signal values having a size of 4*6 are summed in the column direction and expressed as self-capacitance values 330 in the row direction. SCx0 indicates a value generated by adding Cx0, Cx1, Cx2, Cx3, Cx4, and Cx5.

Referring to FIG. 5D, signal values having a size of 4*6 are summed in the row direction and expressed as self-capacitance values 340 in the column direction. SC0y indicates a value generated by adding C0y, C1y, C2y, and C3y.

In the present specification, mutual-capacitance values may be referred to as signal values, self-capacitance values may be referred to as compressed signal values, self-capacitance values in a row direction may be referred to as compressed signal values in a column direction, and self-capacitance values in a column direction may be referred to as compressed self-capacitance values in a row direction.

Referring back to FIG. 4, in operation S220, the touch screen controller 240 identifies or sets the number of bits to be allocated to each of DCT coefficients, which are generated by performing the DCT on the self-capacitance value in the row direction. The number of bits to be allocated to each of the DCT coefficients may be set by the touch screen controller 240 or may be preset, and the touch screen controller 240 may identify the preset number of bits stored in the memory 250.

In operation S230, the touch screen controller 240 identifies a quantization coefficient, which is a coefficient for quantizing the DCT coefficients. The quantization coefficient is a number which divides each DCT coefficient. The touch screen controller 240, as a quantization unit, subtracts 1 from a maximum value that can be expressed by the number of bits allocated to a DCT coefficient. For example, when 8 bits are allocated to the DCT coefficient, the quantization unit is 255(=2⁸⁻1). The touch screen controller 240 predicts a maximum value of the DCT coefficient and calculates the quantization coefficient by dividing the predicted maximum value by the quantization unit. The quantization unit may be set by the touch screen controller 240 or may be preset, and the touch screen controller 240 may identify a preset quantization coefficient stored in the memory 250.

In operation S240, the touch screen controller 240 calculates DCT coefficients by performing the DCT on the self-capacitance values in the row direction.

In operation S250, the touch screen controller 240 quantizes the DCT coefficients by using the quantization coefficient and transmits the quantized DCT coefficients to the controller 170 through the interface 260.

FIGS. 6A to 6C are views describing DCT and quantization according to an embodiment of the present disclosure.

Referring to FIG. 6A, the self-capacitance values 330 are displayed in the row direction.

Referring to FIG. 6B, DCT coefficients 410 are generated by performing DCT on the self-capacitance values 330 in the row direction. D_SCx0 refers to a DCT coefficient of SCx0. DCT coefficients are arranged in an order from a low frequency to a high frequency, and therefore D_SC00 corresponds to a lowest frequency component may be referred to as a direct current component.

An example of an Equation of DCT is as follows.

$$C ( u ) = \sqrt{\frac{2}{N}} {\sum }_{x = 0}^{N - 1} f ( x ) cos \frac{( 2 x + 1 ) u π}{2 N} \qquad Equation 1$$

In Equation 1, u (=0˜N−1) denotes an arrangement order of the DCT coefficient, C(u) denotes D_Scu0, N denotes the total number of self-capacitance values in the row direction, and f(x) denotes Cx0 or SCx0.

Referring to FIG. 6C, values 420 generated by quantizing the DCT coefficients by using the quantization coefficient are illustrated. Q_SCx0 indicates a value generated by dividing D_SCx0 by the quantization coefficient. When D_SCx0 is divided by the quantization coefficient, a remainder (that is, a decimal except for an integer of the divided value) is rounded off For example, the touch screen controller 240 allocates 8 bits, 7 bits, 5 bits, and 2 bits to D_SC00, D_SC10, D_SC20, and D_SC30, respectively, sets the quantization unit as 255 (=2⁸⁻1), predicts a maximum value of D_SC00 located at the beginning, and divides the predicted maximum value by the quantization unit to calculate the quantization coefficient. At this time, the maximum value of D_SC00 may be predicted through an experiment.

Referring back to FIG. 4, in operation S260, the touch screen controller 240 extends self-capacitance values in the column direction according to a preset extension scheme such that the number of self-capacitance values in the column direction becomes a multiple of the number of self-capacitance values in the row direction (that is, N). In the embodiment of the present disclosure, since the number of self-capacitance values in the column direction is 6, SC06 and SC07 are added to make the number of self-capacitance values in the column direction 8. When the number of self-capacitance values in the column direction (that is, M) is a multiple of the number of self-capacitance values in the row direction (that is, N), operation S260 may be omitted.

The preset extension scheme may be a symmetric extension scheme, a linear extension scheme, a zero extension scheme or the like.

In the symmetric extension scheme, SC06 and SC07 have the same values as values of symmetrical positions, that is, values of SC01 and SC00 among the self-capacitance values in the column direction. In the linear extension scheme, SC06 and SC07 have the same values as the same number of previous values of SC06 and SC07, that is, values of SC04 and SC05 among the self-capacitance values in the column direction. In the zero extension scheme, SC06 and SC07 have preset values (for example, 0) or the same values as the previous value (i.e., the value of SC05) thereof.

In operation S270, the touch screen controller 240 performs DCT and quantization on M self-capacitance values in the column direction in the unit of N. In an embodiment of the present disclosure, the self-capacitance values in the column direction are divided into two groups and the touch screen controller 240 individually performs the DCT and quantization on each of the two groups. Thereafter, the touch screen controller 240 transmits each of the two groups which have passed through the DCT and quantization to the controller 170 through the interface 260.

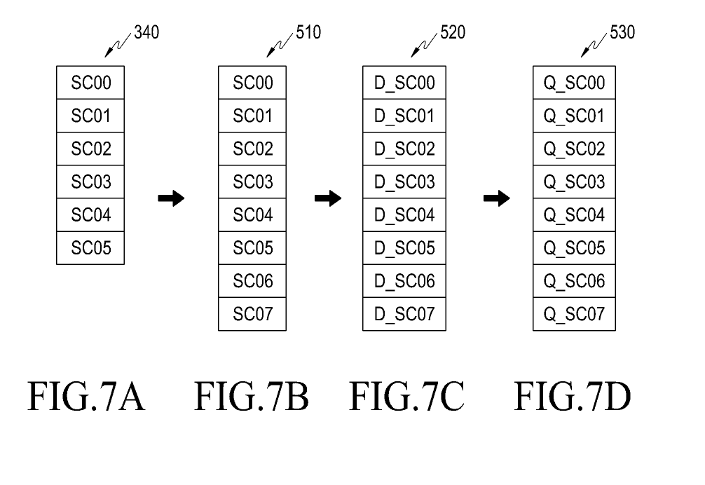

FIGS. 7A to 7D are views describing an extension of self-capacitance values in a column direction and calculation and quantization of DCT coefficients according to an embodiment of the present disclosure.

Referring to FIG. 7A, the self-capacitance values 340 in the column direction are illustrated.

Referring to FIG. 7B, the extended self-capacitance values 510 in the column direction with the addition of SC06 and SC07 are illustrated.

Referring to FIG. 7C, DCT coefficients 520 are generated by performing DCT on the extended self-capacitance values 510 in the column direction. D_SC0y refers to a DCT coefficient of SC0y. The extended self-capacitance values 510 in the column direction are divided into a first group D_SC00˜D_SC03 and a second group D_SC04˜D_SC07 and the DCT is individually performed on each of the groups. DCT coefficients of each group are arranged in an order from a low frequency to a high frequency, and D_SC00 corresponding to a lowest frequency component in each group may be referred to as a direct current component.

An example of an Equation of DCT in each group is as follows.

$$C ( v ) = \sqrt{\frac{2}{N}} {\sum }_{y = 0}^{N - 1} f ( y ) cos \frac{( 2 x + 1 ) v π}{2 N} \qquad Equation 2$$

In Equation 2, v (=0˜N−1) denotes an arrangement order of the DCT coefficient, C(v) denotes D_SC0v, N denotes the total number of self-capacitance values in the row direction, and f(y) denotes C0y or SC0y.

Referring to FIG. 7D, values 530 are generated by quantizing the DCT coefficients by using the quantization coefficient. Q_SC0y indicates a value generated by dividing D_SC0y by the quantization coefficient. When D_SC0y is divided by the quantization coefficient, a remainder (that is, a decimal except for an integer of the divided value) is rounded off For example, the touch screen controller 240 allocates 8 bits, 7 bits, 5 bits, and 2 bits to D_SC00, D_SC01, D_SC02, and D_SC03, respectively, sets the quantization unit as 255 (=2⁸⁻1), predicts a maximum value of D_SC00 located at the beginning, and divides the predicted maximum value by the quantization unit to calculate the quantization coefficient. Like the above, the touch screen controller 240 allocates 8 bits, 7 bits, 5 bits, and 2 bits to D_SC04, D_SC05, D_SC06, and D_SC07.

In operation S280, the touch screen controller 240 performs DCT and quantization on N*M mutual-capacitance values in the unit of rows. In an embodiment of the present disclosure, 4*6 mutual-capacitance values are divided into six groups and the touch screen controller 240 individually performs the DCT and quantization on each of the six groups. Thereafter, the touch screen controller 240 transmits each of the six groups which have passed through the DCT and quantization to the controller 170 through the interface 260.

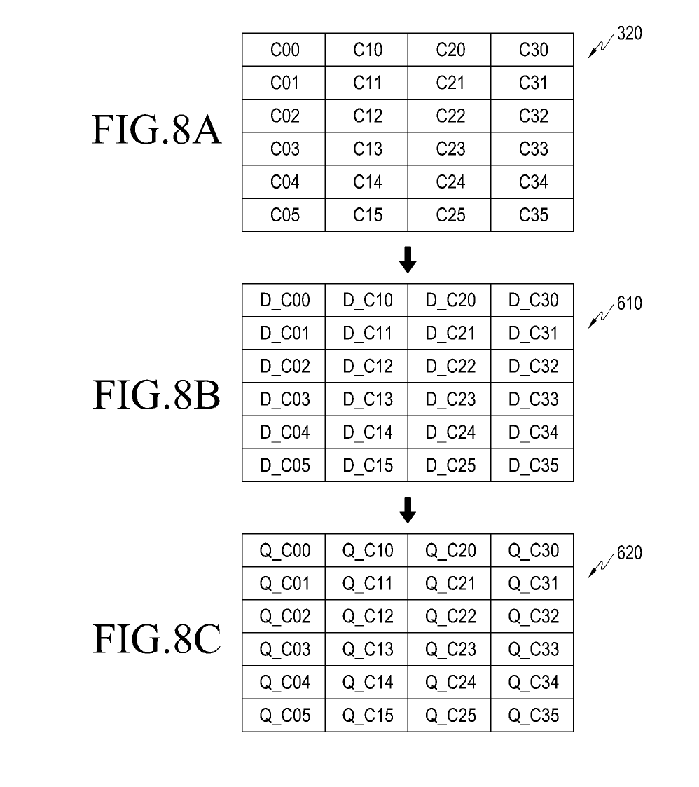

FIGS. 8A to 8C are views describing DCT and quantization for mutual-capacitance values according to an embodiment of the present disclosure.

Referring to FIG. 8A, the mutual-capacitance values 320 are illustrated.

Referring to FIG. 8B, DCT coefficients 610 are generated by performing DCT on the mutual-capacitance values. D_Cxy refers to a DCT coefficient of Cxy. The DCT coefficients 610 are arranged in an order from a low frequency to a high frequency in each of the row and column direction. D_C00 corresponding to a lowest frequency component may be referred to as a direct current component and D_C35 corresponds to a highest frequency component.

An example of an Equation of DCT in each group is as follows.

$$C ( u , v ) = \sqrt{\frac{2}{N}} {\sum }_{x = 0}^{N - 1} f ( x , y ) cos \frac{( 2 x + 1 ) u π}{2 N} \qquad Equation 3$$

u (=0˜N−1) denotes an arrangement order of the DCT coefficient in each group, v (=0˜M−1) denotes a row number of each group, C(u,v) denotes D_Cuv, N denotes a horizontal length of the mutual-capacitance value (that is, a total number of self-capacitance values in the row direction), and f(x,y) denotes Cxy.

Referring to FIG. 8C, values 620 are generated by quantizing the DCT coefficients by using the quantization coefficient. Q_Cxy indicates a value generated by dividing D_Cxy by the quantization coefficient. When D_Cxy is divided by the quantization coefficient, a remainder (that is, a decimal except for an integer of the divided value) is rounded off For example, the touch screen controller 240 may allocate 8 bits to D_C00 and DCT coefficients in the same column as that of D_C00, 7 bits to D_C10 and DCT coefficients in the same column as that of D_C10, 5 bits to D_C20 and DCT coefficients in the same column as that of D_C20, and 2 bits to D_C30 and DCT coefficients in the same column as that of D_C30. The touch screen controller 240 may set the quantization unit as 255 (=2⁸⁻1), predict a maximum value of D_C00 located at the beginning, and divide the predicted maximum value by the quantization unit to calculate the quantization coefficient.

It may be appreciated that the various embodiments of the present disclosure may be implemented in software, hardware, or a combination thereof. For example, in the configurations shown in FIG. 1 and FIG. 2, each component such as the storage unit, the memory, the communication unit, the interface, the controller, and the touchscreen controller may be implemented as a device. Further, software may be stored in, for example, irrespective of being erasable or rewritable, a volatile or non-volatile storage device such as a ROM, a memory such as a RAM, a memory chip device, or an integrated circuit, an optically or magnetically recordable and non-transitory machine (e.g., a computer) readable storage medium such as a CD, a Digital Versatile Disk (DVD), a magnetic disk, or a magnetic tape. It can be appreciated that the storage unit or memory included in the electronic device or touchscreen is an example of a non-transitory machine-readable storage medium suitable to store a program or programs including instructions for implementing various embodiments of the present disclosure. Accordingly, the present disclosure includes a program that includes a code for implementing an apparatus or a method defined in any claim in the present specification and a non-transitory machine-readable storage medium that stores such a program. Further, the program may be electronically transferred by a predetermined medium such as a communication signal transferred through a wired or wireless connection, and the present disclosure appropriately includes equivalents of the program.

Further, the electronic device can receive the program from a program providing apparatus wired or wirelessly connected to the device and store the received program. The program providing apparatus may include a memory for storing a program including instructions for allowing the electronic device or touchscreen to perform the method of processing data by a touchscreen and information required for the method of processing data by a touchscreen, a communication unit for performing wired or wireless communication with the electronic device, and a controller for transmitting the corresponding program to the electronic device at the request of the electronic device or automatically.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of processing data by a touch screen, the method comprising:
receiving signals having signal values from a touch panel;
identifying parameters for compressing the signal values of the received signals;
compressing the signal values based on the parameters; and
transmitting the compressed signal values to a controller through an interface of the touch screen.

2. The method of claim 1, further comprising calculating user input information from the signal values and transmitting the calculated user input information to the controller through the interface.

3. The method of claim 1, wherein the signal values are discrete cosine-transformed and quantized based on the parameters.

4. The method of claim 3, wherein the parameters include a number of bits of a Discrete Cosine Transform (DCT) coefficient, a quantization coefficient, and a look-up table which stores cosine values used for DCT.

5. The method of claim 1, wherein the touch panel includes cells having a matrix structure, and the signal values include row direction self-capacitance values expressed by compressing values of the matrix structure output from the cells into values of one row and column direction self-capacitance values expressed by compressing the values of the matrix structure into values of one column.

6. The method of claim 5, further comprising:
selecting self-capacitance values in a direction having a relatively short length from the row direction self-capacitance values and the column direction self-capacitance values;
compressing the selected self-capacitance values through Discrete Cosine Transform (DCT) and quantization;
extending self-capacitance values in a direction having a relatively long length such that the self-capacitance values in the direction having the relatively long length among the row direction self-capacitance values and the column direction self-capacitance values have a length corresponding to a multiple of the self-capacitance values in the direction having the relatively short length; and
compressing the extended self-capacitance values through DCT and quantization in a unit of short lengths.

7. The method of claim 6, wherein the extension is performed using a symmetric extension scheme in which values added to the extended self-capacitance values have equal values to values of corresponding positions, a linear extension scheme in which values added to the extended self-capacitance values have equal values to previous values thereof, or a zero extension scheme in which values added to the extended self-capacitance values have preset values or equal values to previous values thereof.

8. The method of claim 1, wherein the touch panel includes cells of a matrix structure, and the signal values include mutual-capacitance values indicating values of the matrix structure output from the cells.

9. The method of claim 8, further comprising:
selecting a row from the mutual-capacitance values;
compressing the mutual-capacitance values of the selected row through Discrete Cosine Transform (DCT) and quantization; and
repeatedly performing the selecting of a row and the compressing of mutual-capacitance values on all remaining values of the mutual-capacitance values.

10. A non-transitory machine-readable storage medium for recording a program, which when executed, causes at least one processor to perform a method of processing data by a touch screen, the method comprising:
receiving signals having signal values from a touch panel;
identifying parameters for compressing the signal values of the received signals;
compressing the signal values based on the parameters; and
transmitting the compressed signal values to a controller through an interface of the touch screen.

11. A touch screen comprising:
a touch panel configured to output signals having signal values in response to a touch;
a memory configured to store parameters for compressing the signal values;
an interface configured to communicate with a controller; and
a touch screen controller configured to compress the signal values based on the parameters and to transmit the compressed signal values to the controller through the interface.

12. The touch screen of claim 11, wherein the touch screen controller calculates user input information from the signal values and transmits the calculated user input information to the controller through the interface.

13. The touch screen of claim 11, wherein the touch screen controller performs Discrete Cosine Transform (DCT) and quantization on the signal values based on the parameters.

14. The touch screen of claim 13, wherein the parameters include a number of bits of DCT coefficient, a quantization coefficient, and a look-up table which stores cosine values used for the DCT.

15. The touch screen of claim 11, wherein the touch panel includes cells having a matrix structure, and the signal values include row direction self-capacitance values expressed by compressing values of the matrix structure output from the cells into one row and column direction self-capacitance values expressed by compressing the values of the matrix structure into one column.

16. The touch screen of claim 15, wherein the touch screen controller selects self-capacitance values in a direction having a relatively short length from the row direction self-capacitance values and the column direction self-capacitance values, compresses the selected self-capacitance values through Discrete Cosine Transform (DCT) and quantization, extends self-capacitance values in a direction having a relatively long length such that the self-capacitance values in the direction having the relatively long length among the row direction self-capacitance values and the column direction self-capacitance values have a length corresponding to a multiple of the self-capacitance values in the direction having the relatively short length, and compresses the extended self-capacitance values through DCT and quantization in a unit of short lengths.

17. The touch screen of claim 16, wherein the extension is performed using a symmetric extension scheme in which values added to the extended self-capacitance values have equal values to values of corresponding positions, a linear extension scheme in which values added to the extended self-capacitance values have equal values to previous values thereof, or a zero extension scheme in which values added to the extended self-capacitance values have preset values or equal values to previous values thereof.

18. The touch screen of claim 11, wherein the touch panel includes cells of a matrix structure, and the signal values include mutual-capacitance values indicating values of the matrix structure output from the cells.

19. The touch screen of claim 18, wherein the touch screen controller selects a row from the mutual-capacitance values, compresses the mutual-capacitance values of the selected row through Discrete Cosine Transform (DCT) and quantization, and repeatedly performs the selection of a row and the compression of mutual-capacitance values on all remaining values of the mutual-capacitance values.

20. The touch screen of claim 18, wherein the interface performs an Inter-Integrated Circuit (I2C) connection with the controller.
